(19) United States
(12) Patent Application Publication
(10) Pub. No.: US 2015/0022032 A1
(43) Pub. Date: Jan. 22, 2015

(54) Molded Segment for an Energy Conversion System and Production of Such a Segment

(71) Applicant: SmartMotor AS, Trondheim (NO)

(72) Inventor: Jörg Höyland, Trondheim (NO)

(21) Appl. No.: 14/375,172

(22) PCT Filed: Jan. 23, 2013
(86) PCT No.: PCT/NO2013/050016

§ 371 Date: Jul. 29, 2014

(30) Foreign Application Priority Data
Feb. 2, 2012 (NO) 20120112

(51) Int. Cl. H02K 3/04; H02K 3/34

(52) U.S. Cl. CPC H02K 3/04; H02K 3/34
USPC 310/43

(57) ABSTRACT

The invention describes a segment for an energy conversion system with windings, where the segment consists of at least two objects. The first object comprises coils, insulation and a polymer while the second object comprises at least a polymer and surrounds the first object. A novel feature of the present invention is that the consolidated coils play the role of mechanical support structure in the segment. A production method for a segment for an energy conversion system is also described.

### BACKGROUND

The disclosure relates to a molded segment for an energy conversion system, as well as a method for producing such a segment.

There are various types of electrical machines using non-magnetic materials instead of ferromagnetic materials to achieve certain benefits and there are many different names used to describe such electrical machines. In this document “ironless machines” will be used to describe machines comprising stators without iron in the active area. The term “air-core” is often used for ironless machines but comes originally from air-core coils where no ferromagnetic material is located within the coil or winding. Electrical machines with air-core windings are often called slotless machines. In this document “air-core” and “slotless” machines will be used to describe machines having no slots made of ferromagnetic materials while ironless is used for a machine with a stator not comprising ferromagnetic materials (iron) in the active area. Another term used for some machines is “coreless” which originated from DC machines where the rotor, comprising the armature windings, had no ferromagnetic material. Although very similar to ironless machines, the term will be reserved for DC machines and therefore not be used in this document.

The major advantage of using an ironless stator in an electrical machine is the avoidance of the magnetic attraction between rotor and stator which allows building of machines with very large diameters and extreme torques. This feature is though obtained at the sacrifice of needing stronger magneto-motive force (MMF) to overcome the high magnetic reluctance of the stator. The possible means for creating the high MMF include electromagnets, with conventional or superconducting winding, or permanent magnets (PM).

In the case of ironless machines with PM excitation to provide the stronger MMF, one needs larger amount of permanent magnet materials than on machines with iron cores. This increases the cost of ironless machines which is the major challenge for the technology implementation in cost-sensitive markets.

The ironless permanent magnet synchronous machine (also called iPMSM) is a well-known technology. Probably the first patent on an ironless machine was filed in 1969 (FR6924210 by Societe Nationale Industruelle Aerospatiale, France) describing a flywheel for artificial satellites. A series of publications on iPMSM came in late 1990s and early 2000s and numerous patents were published in 2000s. One of the most relevant patents, U.S. Pat. No. 7,042,109 B2 published in 2004 by Gabrys, describes four different wind turbine configurations using a permanent magnet generator with an ironless stator (described by Gabrys as a “stationary air core armature”).

Several ironless machines have been built since the mid-1990s in kilowatt-range for such applications as micro-generators, electric cars (wheel-motors) and flywheels. However, this technology had not been developed in the megawatt-range until recently.

Generally, ironless machines can be linear or rotating. The rotating machines can further have main fluxes crossing the air gaps in radial or axial direction. In the former case the shape of the stator will be annular while in the latter case—disk-shaped. Diameters of megawatt range ironless machines can be very large. For example, direct driven ironless generators of wind turbines of MW range can have diameters of >10 m for 5 MW or >20 m for 10 MW. Active parts of such electrical machines are segmented. The individual segment can have different shapes, depending on the machine configuration, i.e. planar (linear machine), arced (axial-flux machine) or bent with a large-radius curvature (radial-flux machine).

Tangential tension in ironless machines is usually lower than in traditional machines with ferromagnetic cores but at the same time the Lorenz-forces acting on the conductors are higher in ironless machines. The reason for this is that in conventional machines the electromagnetic forces act mostly on ferromagnetic teeth and only a small fraction of the total force acts on conductors in slots, while in ironless machines 100% of the force (Lorenz-force) acts on the conductors. Therefore, transferring the high forces to the carrying structure to produce torque is a considerable challenge in ironless machines. This problem includes the issue of connection of the individual segments to the carrying structure.

Due to the high periphery speeds and low- or medium-voltage designs, the number of turns in the coils is relatively low and the cross-section of individual turns is relatively large, requiring the use of multiple strands like Litz wire or parallel-connected thin solid conductors to reduce eddy-current losses. The turns consisting of multiple strands are usually very flexible mechanically and cannot transfer any forces. In addition, Litz wire is known for low thermal conductivity, which makes heat removal a problem.

Further, the challenge in large ironless machines is structural strength of each segment. In conventional machines the strength is intrinsically given by the iron cores, while in ironless machine there is no core in the stator, rotor or both, so some other methods to keep integrity of the segments, which can have a length up to several meters each, should be found.

Another challenge is brought by the environmental and operational cycles, leading to wide variation of the external and internal temperatures. The combination of materials with different coefficients of thermal expansion leads to high internal forces between the materials. This can damage the insulation or other elements of the segment and can even cause cracks due to thermal forces. The operational environment is often harsh, which brings a separate challenge to protect the active parts from corrosion and degradation.

Additionally, the design should take into account probability of extreme forces in case of fault situations like short-circuits, etc. Cracks in the segments should be avoided in such cases.

Finally, the MW-size machines are usually designed for medium voltages. That sets certain requirements to the insulations system which should be accounted for.

The challenges can be summarized as follows:
How to transfer the Lorenz-forces from the coils to the carryings structure. How to overcome the problem of the mechanically flexible turns.
How to remove heat from Litz wire or the multiple-strand conductors.
How to handle the internal forces inside the segment due to different values of coefficient of thermal expansion for different materials and components.
How to protect the winding in case the machine has open design (no housing) and operates in harsh environment.
How to avoid cracks in the segments in case of extreme forces.
How to ensure reliable electric insulation having all the challenges listed above.

A few of the challenges have been dealt with in the prior art designs discussed below.

Several solutions have been proposed for holding the windings in place and transferring the forces and torques from the winding to the carrying structure. The solution presented by N. F. Lombard, M. J. Kamper in “Analysis and Performance of an ironless stator axial flux PM machine”, IEEE Transaction on Energy Conversion, Vol. 14, No. 4, December 1999, implies coating the winding with a high-strength composite material and molding the winding's end parts into an composite material together with a part of the carrying structure. This is feasible for low power machines with small diameter but the coating will not be able to withstand the extreme forces in machines in the megawatt power range. In WO2005/089327 A2 by C. Gabrys it is proposed a special form to wind the coils on and for keeping the winding in place, maintaining mechanical integrity of the segment and transferring the forces to the carrying structure. This solution can be applied for machines of any power. It should be noted that Gabrys' design would not give the coils protection against environment unless encased in housing. This solution is feasible, though it has the drawback that the special form occupies the space in the active zone which in alternative designs would be used for the copper conductors.

Cooling of the ironless stator is a challenge due to that mechanical stiffness of the stator and ease of cooling are often in contradiction. One way to go around the contradiction is to use water cooling. For example, in NO20084775 B1 by SmartMotor, the cooling liquid flows inside the glass fiber shell (in each segment). The shell which acts as the carrying structure also creates a thermal barrier for convective cooling, so the heat is removed mostly by the fluid. Liquid cooling systems are however not as reliable as air cooling and require heat exchangers. In general the shell provides mechanical strength but also a thermal barrier which prevents convective cooling of the coils by ambient fluid.

It should be noted that for PM-excited ironless machines it is desirable to have the rotor as close to the stator as possible to use less magnet material in the rotor. For machines having two or more rotors, it's desirable to have the rotors as close to each other as possible with the stator coils in between. This means the space (gap) for the stator is confined and that it should be as thin as possible, so it is desirable to fill the available space with as much copper as possible and not by insulation, carrying structure elements, cooling channels, etc.

### SUMMARY

The disclosed embodiments provide a segment for an energy conversion system, for instance an ironless machine, with convective cooling (preferably natural convection) which segment provides lower total weight and lower use of permanent magnet materials than known systems with ironless stators.

This may be achieved in machines with multiple rotors by a combination of short distance between the magnets of the two rotors, increased amount of winding material (copper) in the space between the magnets and efficient cooling of the windings.

Thin segments are provided with high copper-fill factor, able to transfer necessary forces from the individual conductors to the carrying structure and withstand extreme forces without additional mechanical frames or forms, able to withstand highly variable environmental conditions, such as wide temperature variations, and to be protected against harsh environment, so that the gas or liquid in which the machine is deployed can freely move in the gaps between the stator and rotor.

More specifically, a segment according to the disclosure for energy conversion system with windings is that a segment consists of at least two composite objects, where the first object comprises coils, insulation and a polymer and the second object comprises at least a polymer, wherein the second object surrounds the first object. Furthermore, the objects within the segment are molded in at least two stages, where the first molding consolidates the coils and forms the first object and the second molding forms the second object and surrounds the consolidated coils in the segment. The consolidated coils provide significant mechanical support to the segment.

The composite objects disclosed herein can consist of two or more materials, for instance the first object may comprise windings, insulation and a polymer. The polymer is used as a molding material in the molding process, also called the molding. In the molding process, a mold or molding form may be used to give the object a specific shape.

Disclosed herein are segments used in energy conversion systems comprising coils having bundles of thin conductor strands. The bundles consist of conductor strands that are individually insulated and twisted or woven together, like copper Litz-wire, or thin solid conductors not woven together, connected in parallel.

At the first production stage of the segment, the bundles of wire strands are consolidated and impregnated through a vacuum-pressure impregnation (VPI) process using a high strength, low viscosity, electrical insulating polymer. The VPI of the coils enables them to contribute considerably to the structural strength of the segment. As the result, the consolidated coils themselves can act as supporting frames or carrying structures, thus having two functions: (1) to carry the electric currents and produce the electro-magnetic forces (torque) and (2) to withstand the mechanical loads. In addition to providing coils that can contribute to the structural strength, the molding process provides an improved thermal conductivity of the coils by filling the air voids inside the coils with the polymer material.

At the second production stage, the consolidated coils are, according to the disclosure, molded with a second polymer material to provide a consolidated segment of the energy conversion system. The second polymer binds the windings together and provides a segment that allows thermal expansion and contractions, is environmentally protected and transfers forces from the coils.

There are different preferred characteristics for the different molding materials to be able to provide a segment for an energy conversion system. The first molding material preferably provides a high strength polymer to withstand most of the forces the coils and the segment are exposed to. The segment according to the disclosure ideally withstands the gravitational pull on the segment in addition to the Lorenz-forces produced by the interaction of the currents in the coils and the magnetic flux going through the segment. The molded coils act as a frame providing an energy conversion system that maximizes the use of current conductors because the need for other type of supporting frames is superfluous.

The second polymer also contributes to the structural strength of the energy conversion system, and is also sufficiently flexible to endure contraction and expansion due to temperature changes. Both of the molds have thermal conductivity sufficient to be able to cool the coils inside the molds sufficiently.

Another characteristic of the disclosed segment is that heat generated in the coils dissipates from the surface of the segment by radiation and convection to a surrounding fluid, preferably air or water, and it is therefore no need for a cooling fluid circulating inside the segment. Efficient cooling is according to the invention achieved by having as thin insulation around the coils as possible and having no supporting elements around the active zone of the segment other than the coils themselves.

Higher compactness and lower weight of the machine are achieved by having as much copper in the active zone as possible, due to absence of supporting elements in the active zone.

Further details and preferable features of the disclosure will appear from the following detailed description.

### BRIEF DESCRIPTION OF THE DRAWINGS

The invention will below be described in detail with reference to accompanying drawings, where:

FIG. 1 shows a prior art ironless machine with one stator and two rotors,

FIGS. 2A-B show cross sections of one side of a coil according to the present invention,

FIGS. 3A-B show different coils and coil arrangements,

FIG. 4 shows the ability of a coil to withstand forces and torques, and

FIGS. 5A-B show cross sections of a segment according to the invention.

### DETAILED DESCRIPTION

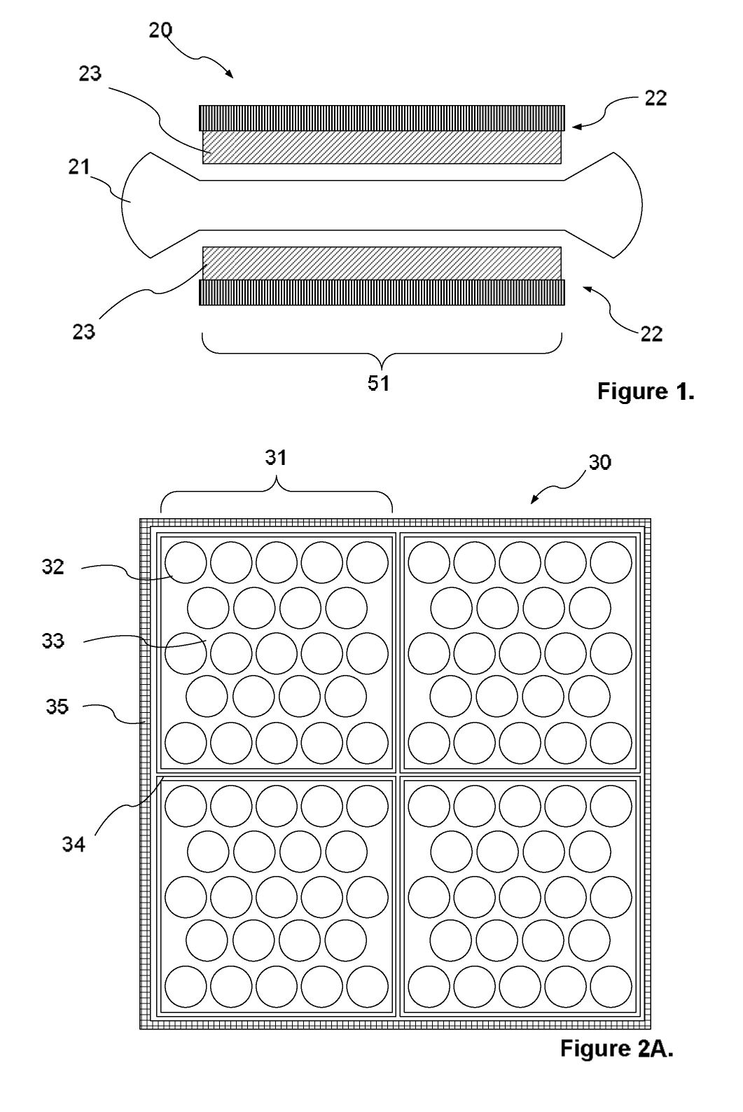

FIG. 1 shows a cross section of an energy conversion system 20 where the stator 21 with coils (not shown) is arranged between to moving parts 22 having permanent magnets 23. The stator 21 located between the two moving parts 22 is ironless, thus not having any ferromagnetic material in an active area 51 between the magnets 23.

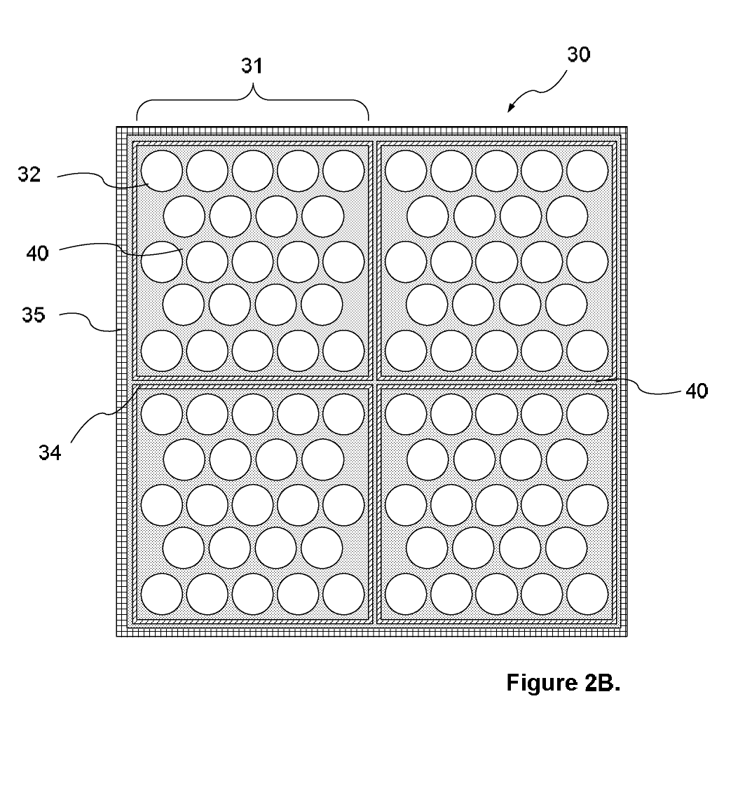

Reference is now made to FIGS. 2A-B which show cross sections of one side of a coil 30 made out of bundles 31 of conductor strands 32 that are individually insulated. Each bundle 31 of conductors 32 represents a turn in the coil 30 and each turn is insulated from the other turns by use of turn insulation 34 wrapped around the bundle 31. The bundles 31 comprise thin conductor strands 32 or wires, individually insulated and twisted or woven together, like copper Litz wire, or of thin solid conductors not woven, connected in parallel. Each coil 30 according to the invention is insulated with wall insulation 35 which is wrapped around the turns to provide electrical insulation between the coil 30 and its surroundings. FIG. 2A shows a coil 30 prior to consolidation and molding which is mechanically very flexible and has a low thermal conductivity across the coil cross section due to air voids 33 between the conductors 32. FIG. 2B shows a coil 30 after consolidation and molding where the air voids 33 are filled with a polymer 40, preferably an epoxy. The first molding process uses a vacuum-pressure impregnation (VPI) process with a high strength polymer and the consolidated coil 30 gets mechanically stiff and has a better thermal conductivity across the coil cross section than a non-consolidated coil.

The VPI of the coils 30 can be done one coil 30 at the time, one coil group at the time or with all the coils or windings in one segment together. By impregnating the coils 30 one by one, the production machinery can be smaller than impregnating all the coils 30 together at once. On the other hand, impregnating all the coils 30 in one segment also provides protection of the connection between the coils 30.

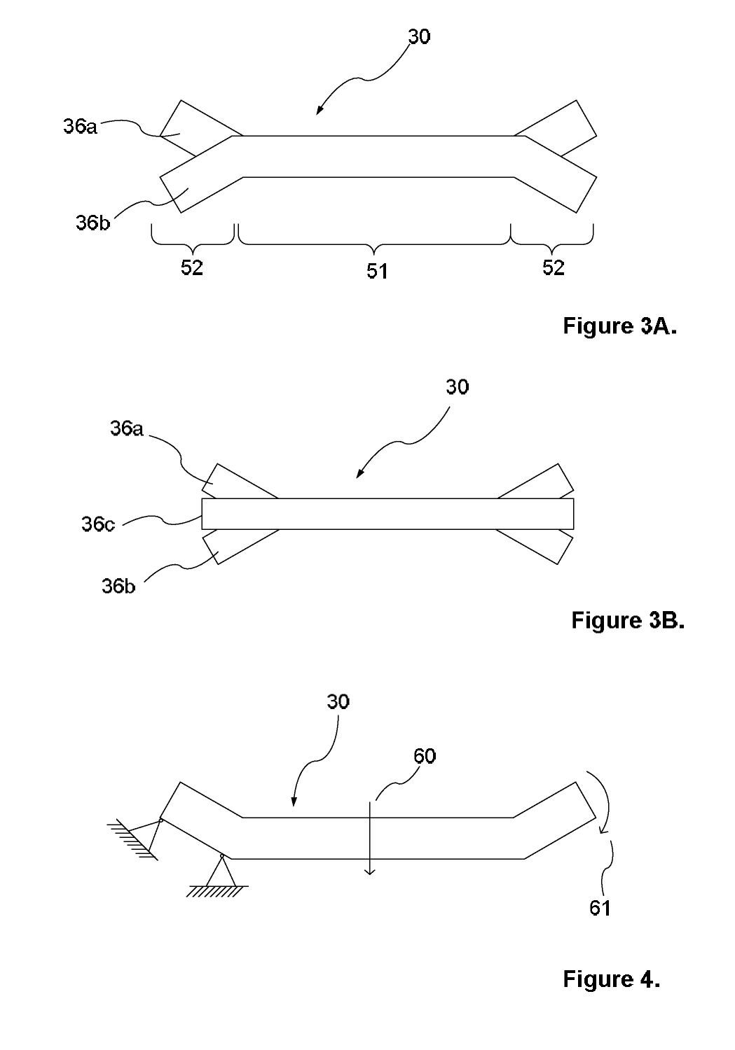

Reference is now made to FIGS. 3A-B which show embodiments of coils 30 for a segment 66 according to the disclosure for an energy conversion system 20. The coils 30 are molded according to the above description and provide a stiff frame for the segment 66. The FIGS. 3A-B show the coils 30 from the side where each coil 30 consists of an active force-torque-producing part 51 and two end-winding parts 52. The end-winding part 52 can have different number of layers 36a-c. In FIG. 3A, the number of layers 36a-b at the end-winding part is two, while in FIG. 3B the number of layers 36a-c in the end-winding part is three. The active part 51 of the coils 30 according to the disclosure in both FIG. 3A and 3B consists of only one layer of coils 30 to minimize the thickness of the active part of the segment 66. The coils 30 can be connected in series, in parallel or in some other way (not shown) making phase windings.

Reference is now made to FIG. 4 showing the ability of the disclosed consolidated and impregnated coils 30 to withstand forces 60 and torques 61.

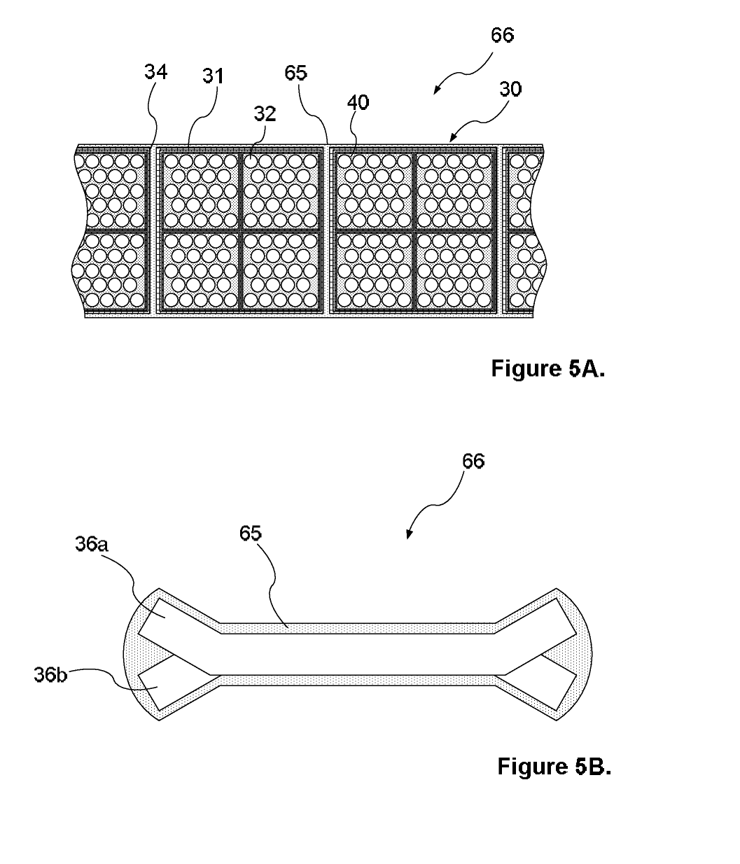

FIGS. 5A-B show segments 66 for an energy conversion system 20 that is molded according to the disclosure. The first polymer 40 consolidates and impregnates the coils 30 providing them with the stiffness and strength to act as a carrying or supporting frame for the segment 66 and to transfer the electromagnetic forces generated by the coils 30. The second polymer 65 further consolidates the whole segment 66, binding the coils 30 together. The second polymer 65 covers the impregnated coils 30 and binds them together. FIG. 5A shows a cross section view along the active part 51 of the segment 66. Each coil 30 is molded according to the description above, and all the coils 30 in the segment 66 are molded through a second molding process using a second polymer 65. The second molding process can be done by using a hollow form for giving a particular shape to the segment 66. The molding material 65 used in the second mold according to the present invention, should have among other things, a good thermal conductivity, be flexible to withstand thermal expansion and compression, and stiff to transfer forces from the coils 30 to a carrying structure. FIG. 5B shows a cross section of a molded segment 66 for an energy conversion system 20 from the side.

The examples given in this document has mainly described energy conversion systems having two moving parts exciting a magnetic field and one molded segment, but an energy conversion system according to the present invention can have any number of moving parts and any number of molded parts or segments.

1-9. (canceled)

10. A segment (66) for an energy conversion system having electrical windings, comprising at least two composite objects, the first composite object comprising coils (30), insulation (34, 35) and a polymer (40) impregnating and consolidating the coils (30) of the first composite object, the first composite object consolidated coils (30) defining support frames or carrying structures in the segment (66), and the second composite object comprising at least one polymer (65) consolidating all of the coils (30) into one segment (66), wherein the second composite object surrounds the first composite object, wherein the segment (66) is ironless.

11. The segment (66) of claim 10, wherein the respective polymers (40, 65) used as molding materials are different from each other.

12. The segment (66) of claim 11, comprising an active area (51) with one layer of coils and two end-winding areas (52).

13. The segment (66) of claim 11, wherein the at least one polymer (65) of the second composite object is more flexible than the polymer (40) of the first composite object.

14. The segment (66) of claim 13, comprising an active area (51) with one layer of coils and two end-winding areas (52).

15. The segment (66) of claim 10, comprising an active area (51) with one layer of coils and two end-winding areas (52).

16. The segment (66) of claim 10, wherein at least one coil (30) has a plurality of bundles (31) of thin conductor wires (32) individually insulated and twisted or woven together or of thin solid conductors not woven, the respective bundles (31) being insulated from each, the bundles (31) forming turns in the coil (30).

17. The segment (66) of claim 11, wherein at least one coil (30) has a plurality of bundles (31) of thin conductor wires (32) individually insulated and twisted or woven together or of thin solid conductors not woven, the respective bundles (31) being insulated from each, the bundles (31) forming turns in the coil (30).

18. The segment (66) of claim 13, wherein at least one coil (30) has a plurality of bundles (31) of thin conductor wires (32) individually insulated and twisted or woven together or of thin solid conductors not woven, the respective bundles (31) being insulated from each, the bundles (31) forming turns in the coil (30).

19. A method for producing a segment (66) for an energy conversion system, comprising the molding steps of:
(a) consolidating and impregnating coils (30) comprising a plurality of bundles (31) of conductor wires (32), and
(b) consolidating one or more of the resulting objects from step (a).

20. The method of claim 19, comprising using at least two different polymers (40, 65) as materials for molding.

21. The method of claims 20, wherein the conductor wires (32) are individually insulated and twisted or woven together, and the respective bundles are insulated from each other, the bundles of at least one coil form turns in said coil (30) as a basis for step (a).

22. The method of claims 19, wherein the conductor wires (32) are individually insulated and twisted or woven together, and the respective bundles are insulated from each other, the bundles of at least one coil form turns in said coil (30) as a basis for step (a).
